(19) United States
(12) Patent Application Publication
(10) Pub. No.: US 2021/0401664 A1
(43) Pub. Date: Dec. 30, 2021

(54) SAFE AND EFFICIENT VIBROTACTILE MULTI-CHANNEL STIMULATION FOR THE TREATMENT OF BRAIN DISORDERS

(71) Applicant: The Board of Trustees of the Leland Stanford Junior University, Stanford, CA (US)

(72) Inventor: Peter Alexander TASS, Stanford, CA (US)

(73) Assignee: The Board of Trustees of the Leland Stanford Junior University, Stanford, CA (US)

(21) Appl. No.: 16/625,330

(22) PCT Filed: Jul. 26, 2018
(86) PCT No.: PCT/US2018/043915

§ 371 Date: Dec. 20, 2019

Related U.S. Application Data
(60) Provisional application No. 62/538,581, filed on Jul. 28, 2017.

(51) Int. Cl. A61H 23/02

(52) U.S. Cl. CPC A61H 23/0245; A61H 2201/0165; A61H 2201/1207; A61H 2201/165; A61H 2201/5058; A61H 2205/067; A61H 2201/1635

(57) ABSTRACT

An apparatus for treatment of a patient using vibrotactile multi-channel stimulation includes: (1) multiple vibratory stimulators; (2) multiple fastening mechanisms to secure respective ones of the vibratory stimulators to respective parts of a hand of the patient; and (3) a controller connected to the vibratory stimulators to direct operation of the vibratory stimulators.

### CROSS-REFERENCE TO RELATED APPLICATION

This application claims the benefit of U.S. Provisional Application No. 62/538,581, filed Jul. 28, 2017, the contents of which are incorporated herein by reference in their entirety.

### BACKGROUND

Abnormally strong neuronal synchrony is a hallmark of several brain disorders, such as Parkinson's disease. The pharmacological treatment for Parkinson's disease with, for instance, L-3,4-dihydroxyphenylalanine (L-DOPA) may have significant long-term side effects. High frequency Deep Brain Stimulation (DBS) for Parkinson's disease is the established therapy for patients with medically refractory, advanced Parkinson's disease. However, the surgical procedures involved for DBS, for instance, depth electrode implantation in specific target areas in the brain, are associated with a significant risk. Furthermore, DBS-related surgical procedures as well as chronic, continuous stimulus delivery may cause side effects.

It is against this background that a need arose to develop embodiments of this disclosure.

### SUMMARY

Embodiments of this disclosure are directed to effectively and safely deliver non-invasive, vibrotactile multi-channel stimulation for the treatment of brain disorders characterized by abnormal neuronal synchrony. A goal of this treatment is to induce long-lasting, sustained therapeutic effects that outlast cessation of stimulation, so that a few hours of stimulation delivered regularly or occasionally can provide substantial relief.

To disrupt abnormal neuronal synchrony and to down-regulate abnormally up-regulated synaptic weights by way of multi-channel stimulation, it is desired to separately stimulate different sub-populations of an abnormally synchronized neuronal population. Embodiments of this disclosure achieve this goal of long-lasting desynchronization and, hence, long-lasting relief of symptoms, by way of non-invasive, vibrotactile multichannel stimulation. The multi-channel stimulation of some embodiments is favorably delivered to fingertips of a subject under treatment. However, it can also be applied to other parts of a hand and, in general, to other parts of the body.

Effectively desynchronizing multi-channel stimulation aims to modulate the timing pattern of neuronal populations and, specifically, to cause mutual phase shifts between different stimulated sub-populations. Surprisingly, for some embodiments, this can be achieved by selecting fast-adapting type I (FA I) and/or fast-adapting type II (FA II) units as primary target units, instead of using mechanical stimuli that aim to strongly stimulate more than one, or even all four types of mechanoreceptors (FA I, FA II, slow-adapting type I (SA I), and slow-adapting type II (SA II)) through time-varying indentation. Instead of a strong, single shot-type of stimuli, some embodiments use relatively weaker, modulatory stimuli that change the collective dynamics and, especially cause a desynchronization, of a neuronal population by way of inducing a phase entrainment of different sub-populations to provide superior efficacy and safety. Further benefits include reduction of side effects of medication, and avoiding risks associated with invasive treatments such as deep brain stimulation.

Vibrotactile multi-channel stimulation of embodiments of this disclosure can be applied for the treatment of Parkinson's disease and a number of other brain disorders, such as movement disorders (e.g., essential tremor and dystonia), epilepsy, dysfunction after stroke, depression, obsessive-compulsive disorder, chronic pain syndromes, post-traumatic stress disorder, dissociation in borderline personality disorder, and other brain disorders characterized by abnormal neuronal synchrony. In patients with Parkinson's disease, some embodiments can be applied to (i) provide a non-invasive treatment (in contrast to invasive DBS), and (ii) to provide a non-invasive, non-pharmacological treatment that has the potential to reduce L-DOPA/medication dosage and/or onset of pharmacological treatment and, hence, reduce and/or delay the rate of side effects caused by medication. Also, some embodiments can be applied to provide treatment that causes (sustained) therapeutic effects in patients suffering from spasticity and impairment of motor function after stroke. By a similar token, different forms of medically and surgically intractable epilepsies can be treatable with some embodiments of this disclosure.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1: Burst-like vibrotactile coordinated reset stimulation (vCRS) with high-frequency (about 250 Hz) vibratory bursts (black rectangles) and vCRS period of about 660 ms, delivered via 4 channels. The ordinate is in arbitrary units.

FIG. 2: Burst-like vCRS with high-frequency (about 250 Hz) vibratory bursts (black rectangles) and vCRS period of about 660 ms, delivered via 5 channels. The ordinate is in arbitrary units.

FIG. 3: Vibratory burst at about 250 Hz. The vibration signal, namely the position of the stimulation contact surface, perpendicular to the skin, displays a low-amplitude oscillation (with peak to peak amplitude of about 0.03 mm) around a substantially constant indentation (about 0.5 mm).

FIG. 4: Vibratory burst at about 64 Hz. The vibration signal has a peak to peak amplitude of about 0.25 mm around a substantially constant indentation (about 0.5 mm).

FIG. 5: Burst-like vCRS with low-frequency (about 64 Hz) vibratory bursts and rapidly varying vCRS sequences, delivered via 4 channels. vCRS period is about 660 ms. The ordinate is in arbitrary units.

FIG. 6: Burst-like vCRS with low-frequency (about 64 Hz) vibratory bursts and slowly varying vCRS sequences, delivered via 4 channels. For illustration, random switching occurs after every 4^{th} sequence. Different sequences are indicated by shading: First sequence activates channels 4-2-3-1, and second sequence activates channels 2-3-4-1. vCRS period is about 660 ms. The ordinate is in arbitrary units.

FIG. 7: Burst-like vCRS with low-frequency (about 64 Hz) vibratory bursts and fixed vCRS sequences, delivered via 4 channels. The fixed vCRS sequence (4-2-3-1) is the same as the first sequence in FIG. 6. vCRS period is about 660 ms. The ordinate is in arbitrary units.

FIG. 8: Smooth about 16 Hz vCRS with substantially constant phase relationships between different channels, without pauses. Shading indicate time shifts of stimulus onset resulting in phase shifts between different channels: Phases of vibratory sine wave stimuli are 0°, 90°, 180°, and 270°. Indentation is substantially constant, say about 0.5 mm, for all channels (not shown). The ordinate is in arbitrary units.

FIG. 9: Smooth about 16 Hz vCRS with pauses and substantially constant phase relationships between channels. Format as in FIG. 8.

FIG. 10: Smooth about 16 Hz vCRS with pauses and phase relationships between channels randomly varying after every vCRS ON epoch. Format as in FIG. 8.

FIG. 11: Smooth about 16 Hz vCRS with pauses and phase relationships between channels randomly varying after every second vCRS ON epoch. Format as in FIG. 8.

FIG. 12: (A) An example of vibratory stimulators that patients wore on their hands in order to receive the stimulation. (B) The vibrotactile CR stimulation pattern comprised of 3 consecutive cycles with randomized sequences of four substantially equally spaced vibratory bursts, followed by two silent cycles off stimulation (“pause”). The 3 cycles on, 2 cycles off pattern was repeated periodically. (C) Protocol schedule diagram for the four patients who were off medications for all visits.

FIG. 13. The shank angular velocity traces (red=right shank, blue=left shank) during FW in an example subject at (A) baseline and (B) day 2 ON stimulation. There was a significant decrease in (C) Asymmetry and (D) AR rhythmicity for all patients during the Forward Walking task at baseline, day 2 ON (P<about 0.001), and day 3 ON (P<about 0.001).

FIG. 14. A representative wrist velocity trace (degrees/second) during the wrist flexion extension task at A) baseline, B) Day 3, C) 1 week, and D) 4 week visits. All traces are OFF stimulation.

FIG. 15. Schematic illustration of an example of an apparatus for the non-invasive treatment of a patient using vibrotactile multi-channel stimulation.

FIG. 16. Schematic illustration of another example of an apparatus for the non-invasive treatment of a patient using vibrotactile multi-channel stimulation.

### DESCRIPTION

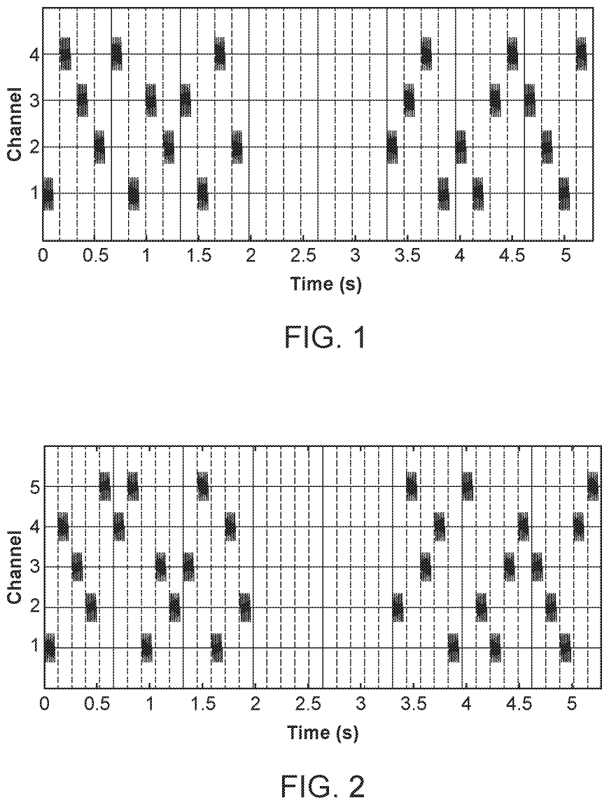

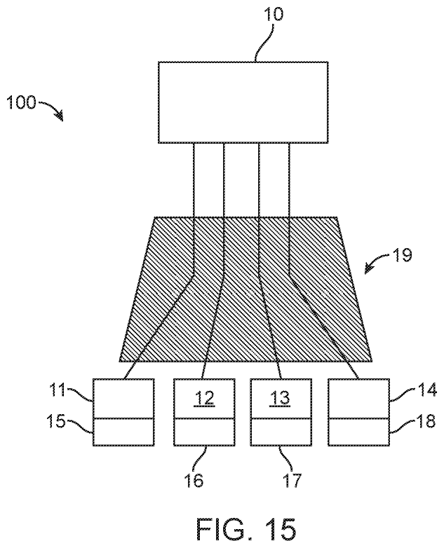

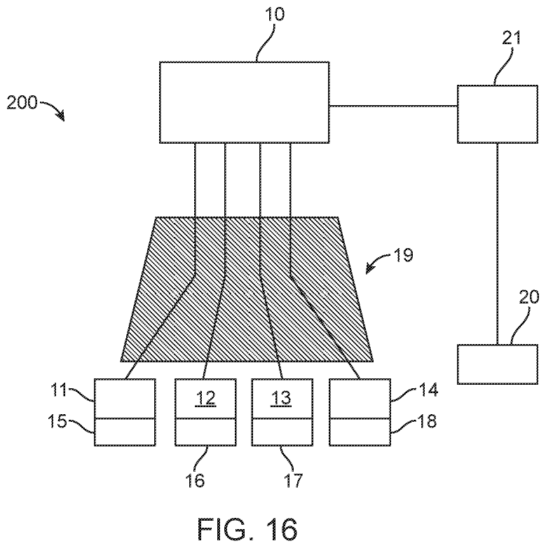

FIG. 15 schematically illustrates an example of an apparatus 100 for the non-invasive treatment of a patient using vibrotactile multi-channel stimulation. The apparatus 100 can be used for the treatment of brain disorders characterized by abnormal neuronal synchrony. The apparatus 100 includes a first vibratory stimulator 11 to generate first vibrotactile stimuli, a second vibratory stimulator 12 to generate second vibrotactile stimuli, a third vibratory stimulator 13 to generate third vibrotactile stimuli, and a fourth vibratory stimulator 14 to generating fourth vibrotactile stimuli. The apparatus 100 shown in FIG. 1 is to be understood as an example implementation, and, more generally, the apparatus 100 can include any other number N of vibratory stimulators to deliver N-channel stimulation, where N is 2 or greater, such as 3, 4, 5, 6, and so forth. The apparatus 100 also includes a controller 10, which is connected to the vibratory stimulators 11 to 14 via wired or wireless connections and which controls the generation of stimuli. The controller 10 also can be integrated in one or more of the vibratory stimulators 11 to 14. The controller 10 can be implemented using a processor and an associated memory storing instructions executable by the processor, or using an application-specific integrated circuit.

The vibratory stimulators 11 to 14 are configured for placement on or next to the skin of the patient. The vibratory stimulators 11 to 14 are placed and secured to different parts of the patient to allow different receptive areas of the skin to be stimulated with temporal and spatial coordination via the vibratory stimulators 11 to 14. In such manner, the stimuli applied to the skin are forwarded via nerve conductors or peripheral nerves to different target regions in the brain of the patient, and, consequently, different target regions in the brain can be stimulated with temporal coordination by the apparatus 100. The vibratory stimulators 11 to 14 can be implemented using piezoelectric actuators or other linear or vibratory actuators.

Depending on the brain disorder to be treated, the vibratory stimulators 11 to 14 can be secured to different parts of the body of the patient, such as to the arm, to the leg, to the hand, to the foot of the patient, or a combination of two or more of the foregoing. As shown in FIG. 15, the vibratory stimulators 11 to 14 are secured to different parts of the hand of the patient and, in particular, to different, respective fingers of the hand via respective fastening mechanisms 15 to 18, which can be implemented as bands of hook-and-loop fasteners or other fixation mechanisms. Also included in the apparatus 100 is a glove 19 to which the vibratory stimulators 11 to 14 and their respective fastening mechanisms 15 to 18 are affixed to further secure the vibratory stimulators 11 to 14 to the hand of the patient, such as to a wrist or a thumb of the patient. The vibratory stimulators 11 to 14 and their respective fastening mechanisms 15 to 18 also can be integrated with the glove 19 as parts of the glove 19. With the aid of the fastening mechanisms 15 to 18, a substantially constant indentation can be applied by each of the vibratory stimulators 11 to 14 to a stimulation surface of a respective finger throughout a treatment duration, which is beneficial in promoting selective stimulation of target mechanoreceptor units of the hand and mitigating against undesired co-stimulation of non-target mechanoreceptor units of the hand. For example, an extent of the indentation can be set to a value in a range of about 0.1 mm to about 1 mm, such as about 0.1 mm to about 0.8 mm, about 0.1 mm to about 0.6 mm, or about 0.5 mm, and a variation of the indentation can be less than or equal to ±10% of the set value, such as less than or equal to ±5%, less than or equal to ±4%, less than or equal to ±3%, less than or equal to ±2%, or less than or equal to ±1%. It is contemplated that a same extent of substantially constant indentation or different, respective extents of substantially constant indentations can be applied by the vibratory stimulators 11 to 14.

The apparatus 100 can be operated according to one of multiple vibrotactile coordinated reset stimulation (vCRS) protocols, or a combination of two or more of such vCRS protocols.

In an example of a first vCRS protocol and while applying the substantially constant indentation explained above, the controller 10 directs the vibratory stimulators 11 to 14 to apply vibrotactile stimuli according to a treatment cycle frequency in a range of about 0.1 Hz to about 60 Hz, such as about 0.5 Hz to about 50 Hz, about 0.5 Hz to about 30 Hz, 0.5 Hz to about 10 Hz, or about 1.5 Hz. Within a treatment cycle, each of the vibratory stimulators 11 to 14 applies a vibratory burst at a different, respective time within the cycle and with a burst frequency different from (e.g., greater than) the treatment cycle frequency. For example, the burst frequency can be in a range of about 100 Hz to about 500 Hz, such as about 128 Hz to about 400 Hz, about 200 Hz to about 300 Hz, or about 250 Hz. A peak to peak amplitude of the vibratory burst can be in a range of about 0.01 mm to about 0.2 mm, such as about 0.01 mm to about 0.1 mm, about 0.01 mm to about 0.05 mm, or about 0.03 mm. A time sequence by which vibratory bursts are applied by the vibratory stimulators 11 to 14 within a treatment cycle can remain fixed across multiple treatment cycles or can vary (e.g., periodically or randomly) across multiple treatment cycles. One or more “off” cycles without vibratory bursts being applied (but while applying the substantially constant indentation) can be interspersed among treatment cycles during which vibratory bursts are applied.

In an example of a second vCRS protocol and while applying the substantially constant indentation explained above, the controller 10 also directs the vibratory stimulators 11 to 14 to apply vibrotactile stimuli according to a treatment cycle frequency in a range of about 0.1 Hz to about 60 Hz, such as about 0.5 Hz to about 50 Hz, about 0.5 Hz to about 30 Hz, 0.5 Hz to about 10 Hz, or about 1.5 Hz. Within a treatment cycle, each of the vibratory stimulators 11 to 14 applies a vibratory burst at a different, respective time within the cycle and with a burst frequency different from (e.g., greater than) the treatment cycle frequency. Here, in the second vCRS protocol, the burst frequency can be in a range of about 10 Hz to about 100 Hz, such as about 10 Hz to about 80 Hz, about 20 Hz to about 70 Hz, about 16 Hz to about 50 Hz, about 30 Hz to about 60 Hz, or about 64 Hz. A peak to peak amplitude of the vibratory burst can be in a range of about 0.05 mm to about 0.5 mm, such as about 0.1 mm to about 0.3 mm, about 0.1 mm to about 0.25 mm, or about 0.25 mm. A time sequence by which vibratory bursts are applied by the vibratory stimulators 11 to 14 within a treatment cycle can remain fixed across multiple treatment cycles or can vary (e.g., periodically or randomly) across multiple treatment cycles. One or more “off” cycles without vibratory bursts being applied (but while applying the substantially constant indentation) can be interspersed among treatment cycles during which vibratory bursts are applied.

In an example of a third vCRS protocol and while applying the substantially constant indentation explained above, the controller 10 directs the vibratory stimulators 11 to 14 to apply vibrotactile stimuli that are time-overlapped but are phase-shifted with respect to one another. A vibration frequency of the vibrotactile stimuli can be in a range of about 1 Hz to about 100 Hz, such as about 1 Hz to about 80 Hz, about 1 Hz to about 50 Hz, about 10 Hz to 35 Hz, or about 16 Hz. A peak to peak amplitude of the vibrotactile stimuli can be set as appropriate, such as in a range of about 0.05 mm to about 0.5 mm, or in a range of about 0.01 mm to about 0.25 mm. Relative phase shifts by which the vibrotactile stimuli are applied by the vibratory stimulators 11 to 14 within a treatment epoch can remain fixed across multiple treatment epochs or can vary (e.g., periodically or randomly) across multiple treatment epochs. One or more pauses or “off” epochs without vibrotactile stimuli being applied (but while applying the substantially constant indentation) can be interspersed among treatment epochs during which vibrotactile stimuli are continuously applied.

FIG. 16 schematically illustrates another example of an apparatus 200 for the non-invasive treatment of a patient using vibrotactile multi-channel stimulation. Certain components and mode of operation of the apparatus 200 can be similarly implemented as explained above in connection with FIG. 15, and repetition of details is omitted. As shown in FIG. 16, the apparatus 200 also includes a sensor 20, which provides a measurement signal obtained from a patient and forwards the measurement signal to the controller 10 via a signal processing unit 21 connected between the sensor 20 and the controller 10.

The sensor 20 can include one or more non-invasive sensors, such as electroencephalography (EEG) electrodes, magnetoencephalography (MEG) sensors, accelerometers, electromyography (EMG) electrodes, or sensors for determining blood pressure, respiration or electric resistance of the skin. The sensor 20 also can include one or more sensors to be implanted in the body of the patient, such as depth electrodes or epicortical electrodes. The signal processing unit 21 can include an amplifier and other signal processing circuitry. The signal processing unit 21 also can be integrated in the controller 10. In addition to, or alternatively to, the sensor 20 measuring a physiological signal, a rating-type of feedback can be implemented using a portable electronic device, in which, via a software application, the patient can rate the extent of his/her symptoms, for example, on a scale between 0 (no symptoms) and 1 (maximal extent of symptoms). The electronic device then communicates with the controller 10, which in turn increases stimulation duration and/or intensity and/or reduced “off” cycles (cycles without stimulation) with increasing symptoms.

The controller 10 directs operation of the vibratory stimulators 11 to 14 using, or responsive to, the measurement signals obtained by the sensor 20. For example, a timing of vibrotactile stimuli applied by the vibratory stimulators 11 to 14 can be adjusted according to measurement of differences in propagation delays, or a vibration frequency of the vibrotactile stimuli can be adjusted according to measurement of local field potentials or other electrophysiological quantities assessed by EEG and/or implanted electrodes.

### EXAMPLES

The following examples describe specific aspects of some embodiments of this disclosure to illustrate and provide a description for those of ordinary skill in the art. The examples should not be construed as limiting this disclosure, as the examples merely provide specific methodology useful in understanding and practicing some embodiments of this disclosure.

### Example 1

### Vibrotactile Coordinated Reset Stimulation for the Treatment of Neurological Diseases—Protocols and Device Specifications

Overview

Coordinated reset stimulation (CRS) includes spatio-temporal sequences of stimuli delivered to different sites in the brain. Computationally, it is shown that by achieving an unlearning of abnormal synaptic connectivity, CRS can cause a long-lasting reduction of pathological synchronization, a hallmark feature of Parkinson's disease and other brain disorders. Preclinical and proof of concept clinical studies in parkinsonian monkeys and patients showed that CRS applied through deep brain stimulation electrodes implanted in the subthalamic nucleus resulted in cumulative and long-lasting therapeutic effects along with a reduction of beta band oscillations. To apply CRS non-invasively, by vibrotactile stimulation delivered to different fingertips, some embodiments present three different possible stimulation protocols. These different CRS approaches target different mechanoreceptors and related stimulus mechanisms. The different approaches are based on the diverse physiology of mechanoreceptors and dynamic CRS principles. Specified stimulation parameters and specifications provide a guideline for technically implementing vibrotactile CRS for clinical tests.

Introduction

Abnormal neuronal synchrony may severely impair brain function as, for instance, in Parkinson's disease (PD). Already in the 19^{th} century it was observed that after a long carriage, train or horseback ride, PD patients experienced marked symptom amelioration. This led to attempts to develop vibratory clinical devices for the treatment of PD which were, however, soon replaced by advanced neurosurgical and pharmacological treatment options. Nowadays, high-frequency (HF) deep brain stimulation (DBS) is the gold standard for the treatment of medically refractory PD. For HF DBS, a train of charge-balanced electrical pulses is permanently delivered at high frequencies (>100 Hz) to target areas like the thalamic ventralis intermedius (VIM) nucleus or the subthalamic nucleus (STN) via chronically implanted depth electrodes.

CRS is developed based on a computational approach targeting on the design of stimulation techniques that specifically counteract abnormal neuronal synchrony by desynchronization. CRS includes characteristic sequences of brief phase resetting stimuli administered to different sub-populations within an abnormally synchronized neural network. The initial computational studies are performed in neural networks with fixed and abnormally up-regulated strength of neuronal interactions. Hence, these model networks generated abnormally synchronized activity, whereas desynchronized states were not stable. Accordingly, the initial intention behind the development of CRS was to restore and maintain desynchronized firing by way of demand-controlled CRS. To this end, a demand-controlled timing of stimulus delivery or periodic administration of CRS with demand-controlled stimulus intensity was performed.

Spike timing-dependent plasticity (STDP) is a fundamental mechanism of the nervous system that allows neurons to adapt the strength of their synapses to the relative timing of their action potentials. Taking into account STDP in computational model networks opened up a qualitatively new perspective for the development of desynchronizing stimulation protocols: in the presence of STDP neural networks became plastic, in mathematical terms “multistable”. The networks could attain qualitatively different attractor states. For instance, a network could be synchronously active with strongly up-regulated synaptic connections. Conversely, the network could be in a desynchronized regime with down-regulated synaptic weights. Hence, the research focus moved from a demand-controlled desynchronization to an induction of long-lasting, sustained beneficial stimulation effects that outlast cessation of properly designed stimulation. From a computational perspective, this is achieved by moving neural networks from pathological model attractor states with abnormally strong synchrony to more physiological model attractor states with down-regulated synchrony. Specifically, in computational studies it is shown that the CRS-induced desynchronization causes a decrease of the rate of coincidences and, in turn, a decrease of the average synaptic weight which may ultimately move the network from “pathological” attractors (with abnormally strong synchrony) to more “physiological” attractors (with desynchronized neural activity). The initial computational studies aimed at the development of invasive brain stimulation therapies for movement disorders and epilepsy.

In a pre-clinical study in Parkinsonian nonhuman primates (MPTP monkeys) electrical CRS was delivered through depth electrodes to the STN with a daily dose of just 2 hours per day during 5 consecutive days. Assessments of motor function showed both acute effects and sustained long-lasting therapeutic aftereffects of CRS-DBS for up to 30 days. In a human proof of concept study in six externalized Parkinsonian patients electrical CRS-DBS, delivered to the STN on 3 consecutive days for up to 2×2 hours per day, caused a significant and cumulative reduction of STN beta oscillations together with a correlated significant improvement of motor function.

Initially, the CRS approach has been developed for invasive brain stimulation, especially DBS. Computationally it is shown that a CRS-induced anti-kindling can also be achieved by way of sensory stimulation. Acoustic CR stimulation was developed to counteract abnormal neuronal synchrony related to chronic subjective tinnitus by way of CRS sound patterns. The tonotopic organization of the central auditory system was employed to allow a separate stimulation of sub-populations. To this end electrical stimulation bursts applied to different brain sites for CRS-DBS were replaced by acoustically delivering tones of different pitch. A clinical proof of concept study demonstrated that therapeutic effects of acoustic CRS achieved in 12 weeks of treatment with a daily dose of 4-6 hours were significant with respect to baseline and persisted through a preplanned 4-week therapy. In addition, electroencephalogram (EEG) recordings demonstrated that the clinical effects of acoustic CRS were combined with a significant decrease of tinnitus-related patterns of abnormal neuronal synchrony.

The somatosensory pathway may provide another opportunity to deliver CRS non-invasively, thereby targeting abnormal neuronal synchrony characteristic of, for instance, movement disorders or epilepsy. However, in contrast to the auditory system, there is a variety of different peripheral somatosensory receptors, carrying information from muscles, tendons, joints and skin, including four types of cutaneous mechanoreceptors. Due to the complexity of the peripheral somatosensory system, there is not just one possible realization of vibrotactile CRS (vCRS) stimulation. Rather, some embodiments of this disclosure present three different protocols for vCRS, based on the response characteristics of the selected target cutaneous mechanoreceptors and related thalamic neurons. These protocols differ with respect to intended stimulus mechanism, resulting stimulus parameter specifications and, hence, the design of possible vibrotactile actuators and the corresponding vCRS patterns. The different vCRS protocols are developed based on basic mechanoreceptor physiology as well as CRS principles and are discussed in the context of first clinical tests.

Technical Features

Selection of Target Cutaneous Mechanoreceptors

For the sake of illustration and brevity, some embodiments focus on an excessive neuronal synchrony in PD, which manifests itself as synchronized oscillatory firing in basal ganglia and exaggerated phase-amplitude coupling (PAC) of beta phase to broadband gamma amplitude in the EEG over sensorimotor cortex. To desynchronize a neuronal population, CRS optimally employs phase resetting stimuli delivered to typically three or more separate sub-populations. Accordingly, the stimulated skin area should have a high density of the selected type of mechanoreceptors, corresponding to a large area representation in primary somatosensory cortex (S1), and the different stimulation sites should have relatively similar vibrotactile sensitivity. As reflected by the sensory homunculus, the cortical representations of the hand and, in particular, the fingers are large compared to that of other parts of the body.

Approximately 17,000 mechanoreceptive units innervate the glabrous skin of the human hand. Based on the response to a sustained step indentation, two major categories of mechanoreceptive afferent units have been classified. The majority (about 56%) of units is fast adapting (FA) and responds to moving stimuli as well as the onset and removal of a step stimulus. In contrast, about 44% of the units are slowly adapting (SA) and respond with a sustained discharge. In addition, based on the properties of their receptive fields both categories are classified into two different types. The fast-adapting type I (FA I) units and the slow-adapting type I (SA I) units have small and well-defined fields. In contrast, the receptive fields of the fast-adapting type II (FA II) units and the slow-adapting type II (SA II) are wider and have obscure borders. FA I units have also been denoted RA (rapidly adapting), whereas FA II units have been denoted as PC (Pacinian corpuscles) units. The four different types of human cutaneous mechanoreceptors respond optimally to qualitatively different stimuli: Edge stimuli and stretch stimuli are optimal for SA I and SA II mechanoreceptors, respectively. SA I units often have a rather irregular sustained discharge, whereas SA II units discharge in a regular manner, but often display spontaneous discharge in the absence of tactile stimulation. In contrast for some embodiments, vibratory perpendicular sinusoidal skin displacements in the about 30 to about 60 Hz range are optimal stimuli for FA I units, whereas vibratory stimuli in the about 100 to about 300 Hz range are optimal stimuli for FA II units. FA I and, especially, SA I units have a pronounced edge contour sensitivity and, hence, their response is stronger when a stimulating contactor surface which is not completely contained in the receptive field. Accordingly, to enhance the FA I responses, instead of a flat, spatially homogenous contactor surface one could use a contactor surface with a spatially inhomogeneous indentation profile.

Controlled Timing by Phase Entrainment

Some embodiments develop three different vCRS aiming at selectively eliciting particularly strong responses of one type of mechanoreceptor units and corresponding thalamic neurons with controlled timing. To this end, use is made of comparably streamlined vibratory stimuli which can be generated with reliable mechanical stimulation devices such as piezo actuators.

CRS aims to modulate the timing pattern of neuronal populations and, specifically, to cause mutual phase shifts between different stimulated sub-populations. Accordingly, to cause brief, phasic mechanoreceptor discharges with controlled timing with technically reduced complexity realization of mechanical stimulators, the FA I and/or FA II units are selected as primary target units for the following reasons.

CRS modulates the collective neuronal discharge pattern by delivering phase resetting stimuli to different sub-populations of a synchronized neuronal population at different times, to mutually shift the phases of the different stimulated sub-populations. A phase reset can be achieved by way of a periodic pulse train or smooth (e.g., sinusoidal) stimulus train of several periods length, by inducing a phase entrainment: within a few periods of the phase entrainment, the neurons' phase dynamics (e.g., discharge timing) gets phase locked to the periodic stimulus and, hence, reset (restarted), independently of its initial dynamic state, as shown computationally in the context of desynchronizing stimulation.

There is experimental evidence for phase entrainment effects of vibratory stimuli at the peripheral as well as central level. For instance, median nerve recordings from single afferent mechanoreceptive units demonstrated that FA I and FA II units preferably discharged on the indentation and retraction phase of vibratory stimuli (in their optimal frequency ranges, about 5-50 Hz and about 100-300 Hz, with amplitudes as low as about −12 dB relative to about 1 mm peak to peak amplitude and less) administered perpendicularly to the skin. FA I units produced fewer impulses at the retraction phase than at the indentation phase, and the number of retraction-related impulses decreased to zero much earlier when lowering the stimulus amplitude. The relationship between vibratory stimulus and discharge patterns of afferent mechanoreceptive units can be assessed by calculating the cycle response, e.g., the average number of vibration-evoked impulses per vibration cycle. For FA II units a cycle response of about 1 is achieved by vibration amplitudes of about −30 dB relative to about 1 mm peak to peak skin displacement (corresponding to about 0.03 mm) and vibration frequencies between about 128 Hz and about 400 Hz. In contrast, for FA I units a cycle response of about 1 is obtained at significantly larger vibration amplitudes, e.g. at about −12 dB (corresponding to about 0.25 mm) and at considerably smaller vibration frequencies, e.g., about 32 Hz.

Neurons in the cutaneous core of the human thalamic somatic sensory nucleus [Ventral caudal (Vc)] respond to vibratory stimuli (with static about 0.5 mm indentation and about 0.1 mm vibration amplitude) quite selectively with a pronounced phase entrainment. The vibratory stimuli used in the study had a static about 0.5 mm indentation and a vibration amplitude of about 0.1 mm. Responses of human Vc neurons to stimuli that optimally activate the four different mechanoreceptors were analyzed, employing about 32 or about 64 Hz vibration for FA I units, about 128 Hz vibration for FA II, edge stimuli for SA I and skin stretch for SA II units. 17 out of 19 neurons had a significantly stronger response to one stimulus as opposed to the other three. Phase entrainment is studied by way of cycle histograms (distributions of the phase difference between neuronal discharge and stimulus phase) as well as the percentage entrainment (the maximum percentage of neurons in any continuous half-cycle of the cycle histogram).

Accordingly, slow-frequency (e.g., at about 30-64 Hz) or high-frequency vibration (e.g., at about 128-400 Hz) added to a constant indentation, allow optimally to cause a phase entrainment of human thalamic Vc neurons and, hence, provide modulation of thalamic discharge patterns with comparatively high timing precision.

Large Cortical Representation

The overall goal is to cause a desynchronization of abnormally synchronized neuronal activity in spatially extended neuronal populations, e.g., in the cortex, with devices of reduced number, size and contact surface. In this context, it is noted that the spatial distribution of mechanoreceptors in different regions of the glabrous skin of the human hand varies considerably. The relative densities of innervation of all four types of mechanoreceptive units in the fingertip vs. the rest of the finger vs. the palm are about 4.2 vs. about 1.6 vs. about 1. The clear majority of mechanoreceptive units in the fingertip are SA I and, in particular, FA I units, with approximately twice as many FA I units as SA I. FA II and SA II units constitute just approximately an eighth of the fingertip mechanoreceptive units. Moreover, the low density of FA II units is relatively uniform from the wrist to the fingertip. In contrast, the density of the FA I units is maximal in the fingertips, strongly drops to the proximal half of the terminal phalanx and undergoes a further, but smaller decrease from the bases of the fingers to the palm.

To stimulate large numbers of mechanoreceptive units and, hence, large corresponding cortical volumes with a reduced number of actuators and a reduced skin contact surface, it is favorable to stimulate the FA I units of the fingertips. Alternatively, the nearly homogenous density of FA II units might allow sparing the fingertips by targeting FA II units on the dorsal part of the middle phalanx. Sparing the fingertips might allow patients to more comfortably use their fingers during treatment delivery. However, this possibly more ergonomic alternative might come with a markedly reduced number of mechanoreceptive units and, thus, smaller brain volume stimulated.

Spatial Selectivity

Different sub-populations engaged in the abnormal neuronal synchronization process should be stimulated separately, with no or little spatial overlap. In this regard, consideration should be made that the receptive field size of FA I and FA II units in the glabrous skin of the human hand is markedly different. With a median of about 12.6 sq. mm FA I receptive fields are about ten times smaller than receptive fields of FA II units. Since FA I units are predominately located in the fingertips with focal receptive fields, their corresponding cortical representation areas can be stimulated with no or little spatial overlap (employing desired FA I vibration parameters given above). In contrast, due to the comparably large receptive fields of FA II units, covering e.g., an entire finger or more, it is of greater importance to use small peak to peak vibration amplitudes of about 0.1 mm or even less, say about 0.03 mm (see above) to avoid spatially widespread activation.

Based on the physiological and computational findings discussed above, three different vCRS protocols are proposed. All three protocols aim at predominately activating one type of mechanoreceptor units, either FA I or FA II.

Protocol #1—Burst-Like vCRS with High Frequency Vibratory Bursts

The vCRS frequency differs from the frequency of the vibratory bursts. For instance, the vCRS frequency can be in a low frequency range, such as delta or theta, e.g., about 1.51 Hz (FIG. 1). In general, the vCRS frequency can be in a range from about 0.5 Hz to about 50 Hz. The vCRS frequency is specified as a vCRS cycle repetition rate. Within one vCRS cycle one about 250 Hz vibratory burst is administered through each channel, respectively. The about 250 Hz vibratory bursts are equidistantly spaced in time. The spacing of the single vibratory bursts can deviate from this alignment by up to ±15% and more. Their duration (e.g., equal to about 100 ms as in FIG. 1) typically does not exceed T/N, where T is the vCRS cycle length and N is the number of channels. Based on computational studies, in other CRS applications CRS was periodically turned on and off during dedicated cycles to enhance the desynchronizing effect. Accordingly, FIG. 1 shows a vCRS pattern with 3 cycles on followed by 2 cycles off stimulation (repeated periodically).

High-frequency vibratory bursts (e.g., at about 128-400 Hz) are used to control the timing of the discharges of the FA II units and corresponding thalamic (e.g., Vc) neurons. vCRS can be delivered via 4 channels, e.g., to the fingertips of all fingers except for the thumb (FIG. 1), ultimately impacting on 4 different cortical sensorimotor sub-populations. In some embodiments, it should typically be 3 or more channels, e.g., 5, corresponding e.g., to the fingertips of all fingers of one hand (FIG. 2).

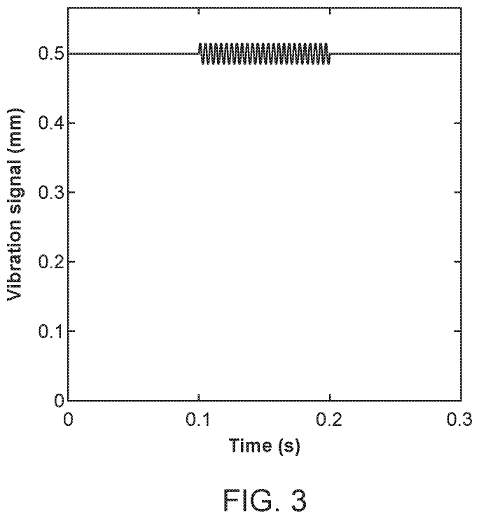

For all channels the indentation of the stimulation contact surface is substantially constant, e.g., about 0.5 mm (FIG. 3), throughout the entire vCRS delivery. The indentation should not vary considerably in time in order to avoid co-stimulation of other, non-target mechanoreceptor units, such as SA I and SA II units. This can be realized by a permanent fixation of the vibratory stimulation device. The peak to peak amplitude is small, e.g., about 0.1 mm or about 0.03 mm (FIG. 3). A vCRS sequence is the sequence of channels by which the vibratory bursts are delivered within one vCRS cycle. For instance, the first two vCRS cycles in FIG. 1 read 1-4-3-2 and 4-1-3-2. The sequence can randomly vary from one vCRS cycle to the next (FIG. 1). Alternatively, the sequence can also undergo slow variations (see below and Discussion). In FIG. 2 the vCRS frequency equals about 1.51 Hz=about 1/660 ms.

The burst-like vCRS with about 250 Hz vibratory bursts at small peak to peak vibration amplitudes of about 0.1 mm or even less, e.g., about 0.03 mm (FIG. 3) aims at predominantly stimulating FA II units and the corresponding thalamic neurons. To stimulate FA II units as selectively as possibly one should stimulate at particularly low peak to peak amplitudes. In addition, to avoid co-stimulation of FA I units, one could stimulate outside of the fingertip, where the density of FA I mechanoreceptors is significantly smaller, e.g., at the dorsal part of the middle phalanx.

Protocol #2—Burst-Like vCRS with Low Frequency Vibratory Bursts

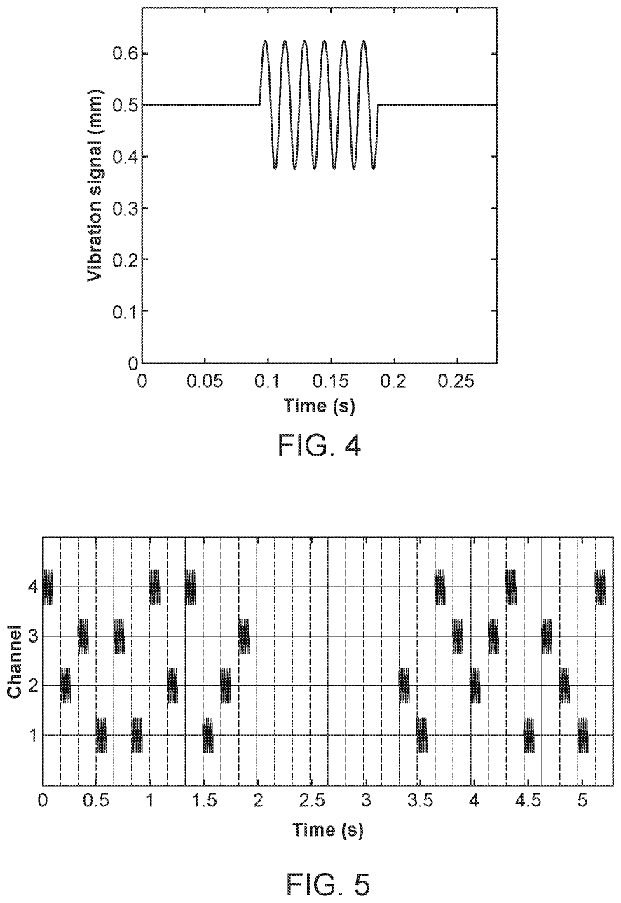

This protocol is similar to the burst-like vCRS with high-frequency vibratory bursts, except for the parameters of the vibratory bursts. To predominately stimulate FA I units and their corresponding thalamic neurons, low-frequency (about 30-60 Hz) vibratory bursts (FIG. 4) are employed with higher peak to peak amplitudes, e.g., about 0.1-0.25 mm. As for the burst-like vCRS with high-frequency vibratory bursts, in this case delivery of vCRS is made via 3 or 4 or 5 channels, e.g., fingertips. This type of stimulation should actually be delivered at the fingertips (as opposed to other parts of the glabrous hand), due to their particularly high spatial density of FA I mechanoreceptors. Also, to stimulate the FA I units even more effectively, instead of a flat, spatially homogenous contactor surface, a contactor surface with a spatially inhomogeneous indentation profile can be used.

Burst-like vCRS with both high-frequency (FIG. 1) and low-frequency vibratory bursts (FIG. 5) can be delivered by randomly varying the vCRS sequence from cycle to cycle. This protocol will be called rapidly varying sequence vCRS. Burst-like vibrotactile multi-channel stimulation with both high-frequency and low-frequency vibratory bursts can be delivered via 3 or more channels (e.g., fingertips). This type of vibrotactile multi-channel stimulation can involve an intra-burst frequency of about 16-50 Hz and peak to peak amplitudes greater than those for FA II units.

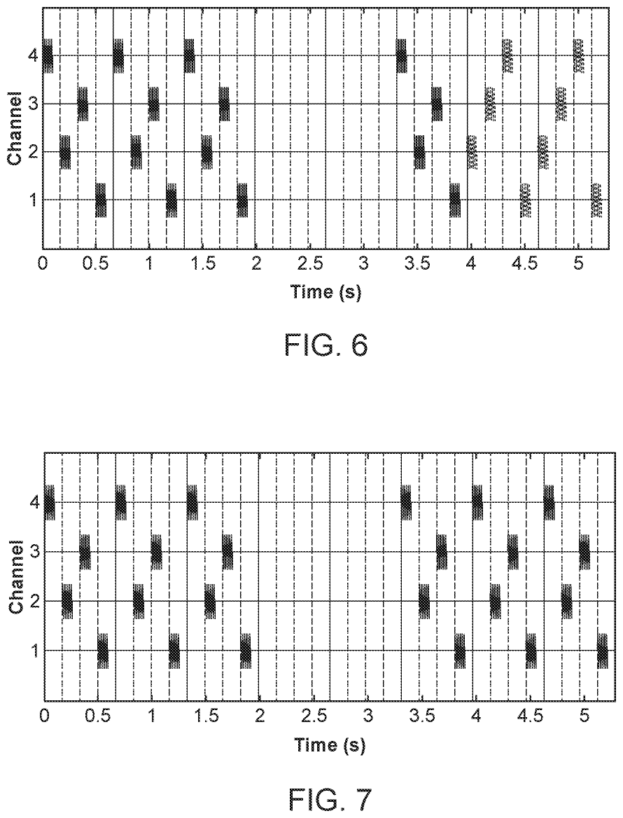

Alternatively, one can also deliver vCRS with slowly varying sequences, where the vCRS sequence is repeated with occasional random switching to the next vCRS sequence. For illustration, in FIG. 6 the number of repetitions is 4. For this type of stimulation mode, in clinical applications, on average at least 10 repetitions can be used. According to computational studies, the slow variation of CRS sequences may increase the anti-kindling effect.

Alternatively, one can perform vCRS with a fixed vCRS sequence (FIG. 7). Burst-like vCRS with both high-frequency or low-frequency vibratory bursts can be delivered via 3 or more channels (e.g., fingertips).

Protocol #3—Smooth vCRS

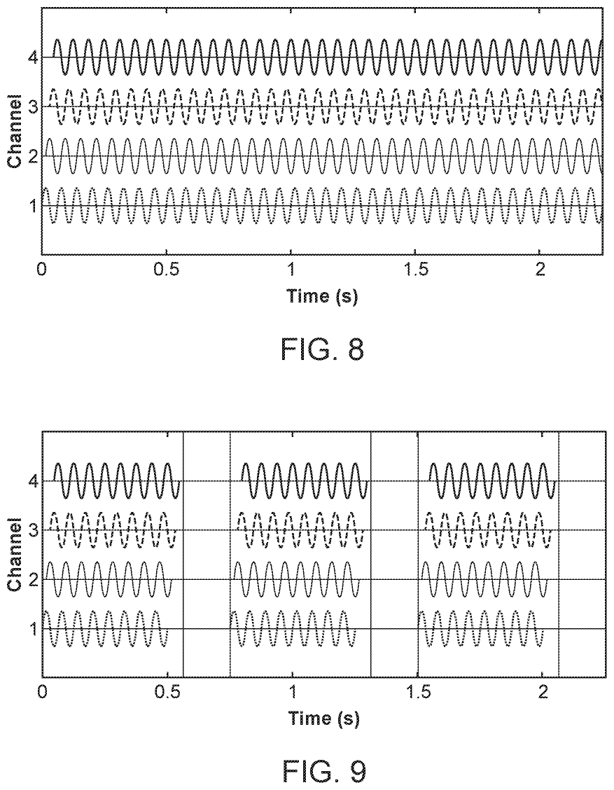

In the two burst-like vCRS protocols discussed above the vCRS frequency (e.g., vCRS cycle repetition rate) and the (intra-burst) frequency of the vibratory bursts is significantly different. The intra-burst frequency (about 250 Hz in FIG. 1, about 64 Hz in FIG. 5) is greater than the vCRS frequency (about 1.51 Hz). Based on the notion of a soft phase rest, a phase resetting vibratory burst is replaced by a smooth vibratory train. Accordingly, mutually time-shifted vibratory bursts (as in FIGS. 1, 3) translate into mutually phase-shifted vibrations (FIG. 8). By the same token, in the case of a smooth vCRS stimulation, the vCRS sequence of vibratory bursts corresponds to the pattern of phase shifts between different channels (FIG. 8). Accordingly, a burst-like vCRS with fixed sequence (FIG. 7) corresponds to smooth vCRS with fixed phase relationships between different channels (FIG. 8).

Smooth vCRS with substantially constant phase relationship between different channels can be realized by continuously delivering vibratory stimulation without pauses (FIG. 8) or with pauses (FIG. 9). In FIG. 9 a vCRS ON epoch, comprising 9 ON cycles with active vibration of at least one channel, is followed by a vCRS OFF epoch of 4 OFF cycles (e.g., a pause). This pattern is repeated periodically. The phase ordering of the 4 channels is identical in all 3 vCRS ON epochs.

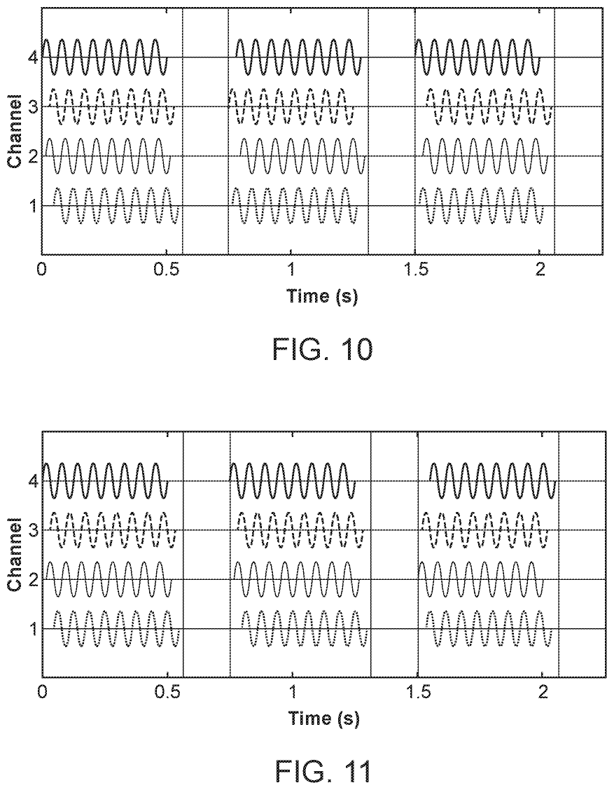

Alternatively, corresponding to the burst-like vCRS with slowly varying sequences presented above, in the case of smooth vCRS the phase relationship may randomly vary from one vCRS ON epoch to the next (FIG. 10).

The phase relationships between channels can also be randomly varied after every n-th vCRS epoch (e.g., n=2 in FIG. 11). In general, for some embodiments, with p=number of vibration periods within one stimulation epoch, n×p should be at least 10. Smooth vCRS can be delivered through 3 or more channels (e.g., fingertips). A difference between the burst-like vCRS and the smooth vCRS protocol is that for burst-like vCRS vibratory stimuli are not simultaneously delivered to different parts of the body (e.g., fingertips).

Discussion

Some embodiments present three different vCRS protocols that can be implemented technically for clinical studies. The goal of all three protocols is to predominantly stimulate either FA I or FA II mechanoreceptors units and their corresponding thalamic neurons. Due to an intended peripheral and, in particular, thalamic phase entrainment, a relevant population of neurons may produce stimulus-entrained discharges. In contrast, stimulating all four types of mechanoreceptors, SA I, SA II, FA I and FA II, may cause stimulus responses with inhomogeneous, compound phasic and tonic timing characteristics. This may lead to less precise timing and, hence, render CRS less effective. In any case, simultaneously stimulating all four types of mechanoreceptor units involves time-varying indentation and, hence, large amplitudes and sophisticated mechanical stimulation devices. In contrast, the stimulation protocols presented here can be realized, e.g., by way of piezo technology.

An advantage of burst-like vCRS at higher intra-burst frequencies, e.g., about 250 Hz, and low peak to peak vibration amplitudes may be the selective activation of FA II units. A potential downside of this approach may be the large receptive field size of FA II units which might hinder selective stimulation of separate sub-populations, in particular, in neurological conditions, such as Parkinson's disease, associated with enlarged receptive field size. Stimulating at high amplitudes may activate remote FA II receptors. This might reduce the desynchronizing effect of CRS and, at particularly large vibration amplitudes, even have undesired, synchronizing effects.

In contrast, burst-like vCRS at lower intra-burst frequencies, e.g., about 32-64 Hz, and low peak to peak vibration amplitudes may favorably activate large and separate FA I-related thalamic populations since the density of the FA I units peaks in the fingertips. Since FA I units specify higher vibration amplitudes, a co-activation of FA II units might occur. To avoid the latter, employment of lower intra-burst frequencies, say about 32 Hz instead of about 64 Hz, may be favorable. However, at about 32 Hz a vibratory burst contains half the periods of about 64 Hz burst, which might reduce efficacy, since both FA I (and FA II) units specify a few (e.g., less than 5) cycles to build up a stable phase entrained stimulus response. This might be compensated for by increasing the duration of the vibratory burst (and, hence, the number of vibration periods). In addition, one might even reduce the vCRS frequency to allow for greater vibratory burst durations.

As an alternative to selectively targeting FA I or FA II units, one could also design compound vibratory stimuli and related devices. For instance, one could simultaneously deliver FA I-targeting burst-like about 32 Hz vibration to the fingertips in combination with FA II-targeting burst-like about 250 Hz vCRS of the dorsal part of the middle phalanx. The vibration frequencies should be commensurate and the vibratory bursts' indentation or retraction could end coincidently or be adapted to measured propagation delays (see below).

Conduction velocities of FA I units and FA II units are similar. FA I conduction velocities are found to range from about 26-91 m/s (with mean 55.3 m/s±3.4 m/s) and FA II conduction velocities from about 34-61 m/s (46.9 m/s±3.6 m/s). Based on computational studies, for low CRS frequencies (e.g., cycle repetition rates, as in FIGS. 1 and 3), e.g., f_{CRS}=about 1.5 Hz, minor variations of the conductance delays of a few ms between units belonging to the same as well as to different stimulated sub-populations would not be expected to render CRS ineffective. However, for precise calibration, the timing of the vibratory stimuli delivered to the different fingers can be adapted to the individually assessed propagation delays by way of vibration evoked potentials of the different fingertips. Differences of these propagation delays can be compensated for by adapting the timing of the onsets of the vibratory stimuli accordingly.

Smooth vCRS can be applied to specifically desynchronize synchronized beta band oscillations (15-35 Hz) in patients with PD. The vibration frequency (about 16 Hz in FIG. 8) can, in principle, be adjusted to local field potential recordings from depth electrodes, epicortical electrodes or EEG electrodes. Given its considerably smaller vibration period (as opposed to the cases of burst-like vCRS), propagation delays will likely matter. Imbalances between different channels may hinder efficacy and, in extreme cases giving rise to multi-channel coincident vibration, potentially cause synchronizing effects. Hence, this approach may benefit from the measurement of propagation delays and the corresponding adaptation of the phase relationships between different channels.

Measuring propagation delays may also help to compensate for interhemispheric delays. Based on computational results, for the burst-like vCRS protocols (FIGS. 1 and 3) one would not expect minor delays to significantly reduce vCRS efficacy. However, this remains to be tested clinically. Furthermore, interhemispheric interference can be avoided by stimulating unilaterally, e.g., by delivering burst-like vCRS to the more affected side. For comparison, in a proof of concept study in externalized PD patients, during three stimulation days CRS STN DBS was administered unilaterally, exclusively contralateral to the more severely affected side. This protocol induced a significant and cumulative reduction of beta band LFP oscillations, along with a significant improvement of motor function.

In computational studies, CRS is typically delivered to three or more separate sub-populations of approximately the same size. Accordingly, it may be favorable, but more involved to adjust the peak to peak vibration amplitude for each fingertip separately, to substantially equalize stimulus response amplitudes (by EEG) or volumes (by functional magnetic resonance imaging (fMRI)) to allow activation of cortical volumes of similar sizes, thereby compensating for the different size of cortical finger representations.

So far, in computational, pre-clinical and clinical studies, CRS is delivered with fixed CRS sequence, with rapidly varying CRS sequence, or with slowly varying CRS sequence. Computationally, CRS with slowly varying sequences may cause a more pronounced anti-kindling. However, again computationally, CRS with rapidly varying CRS sequences may be more robust with respect to mutual detuning of CRS frequency and intrinsic neuronal firing/bursting rate. Accordingly, first pilot studies may reasonably employ burst-like vCRS with high-frequency or low-frequency vibratory bursts and rapidly varying vCRS sequences (FIGS. 1 and 5). By the same token, smooth vCRS should be performed with short vCRS ON epochs comprising a few vibration periods and phase relationships between channels randomly varying after every vCRS ON epoch. The length of the vCRS ON epoch should be sufficient to induce a phase entrainment, but insufficient to cause the specific slowly varying sequences effect, involving 25 or more repetitions of vibration periods with substantially constant phase relationships between channels.

Apart from delivering vCRS to the fingertips, based on the sensory homunculus and the symptoms under consideration, one could deliver vCRS stimulation also to other parts of the body. vCRS might also be tested in other brain disorders characterized by abnormal neuronal synchrony. Possible applications might, for instance, be thalamocortical dysrhythmia-related diseases, such as neurogenic pain or depression.

Conclusion

vCRS can be realized for clinical tests by way of, e.g., piezo technology. Burst-like about 250 Hz vCRS at particularly low amplitudes with rapidly varying vCRS sequence may allow for selective activation of FA II mechanoreceptor units and corresponding thalamic neurons. Burst-like at about 32-64 Hz vCRS at slightly higher peak to peak amplitude and rapidly varying vCRS sequences might be favorable to stimulate large, but separated cortical fingertip representations. A more involved vCRS approach is the smooth vCRS, e.g., with phase relationships between channels randomly varying after every vCRS ON epoch. The smooth vCRS approach may include adaptation of the phase relationships to measured conductance delays.

### Example 2

### Coordinated Reset Vibrotactile Stimulation Shows Prolonged Improvement in Parkinson's Disease

Overview

Coordinated Reset (CR) is a pattern of stimulation designed to disrupt the abnormal synchrony seen in several neurological disorders. CR patterns of deep brain stimulation showed prolonged improvement of motor signs in Parkinson's disease. It is aimed to demonstrate the safety and tolerability of peripheral vibrotactile CR stimulation in Parkinson's disease. Five subjects (four off medication) received about 12 hours of vibrotactile stimulation on their fingertips over three consecutive days. They performed repetitive wrist flexion-extension, forward walking, the UPDRS-III and an adverse effects questionnaire on and off stimulation during the three days, and again off stimulation at one and four week follow up visits. Subjects had no significant adverse effects throughout the study. All subjects tolerated the total of about 12 hours of vibrotactile CR stimulation, and no subject had to stop the stimulation early. Subjects showed an improvement in gait asymmetry and arrhythmicity (P<about 0.001 for both), as well as in frequency of wrist flexion-extension (P=about 0.016) while on stimulation. There was prolonged improvement of gait asymmetry (P=about 0.001) and wrist flexion-extension regularity (P=about 0.021) and velocity (P=about 0.006) off stimulation up to four weeks later. This is a demonstration that vibrotactile CR stimulation is safe and tolerable and improves gait and bradykinesia in Parkinson's disease. Moreover, there was still improvement one and four weeks after stimulation was stopped, indicating a cumulative effect of the stimulation.

Introduction

High frequency (HF) Deep Brain Stimulation (DBS) for Parkinson's disease has been shown to be superior to medical therapy alone in the treatment of advanced Parkinson's disease (PD). However HF DBS involves several invasive procedures, associated with significant risk, and the therapeutic effect of HF DBS specifies that it is on continuously. Both the surgical procedures and the chronic, continuous nature of HF DBS have been associated with adverse effects. Chronic HF DBS can attenuate pathologically exaggerated neuronal oscillations and synchrony in the widespread sensorimotor network.

CR stimulation was initially developed computationally and was designed to counteract neuronal synchrony, by delivering brief high frequency trains in a patterned sequence, so as to reset the phases of sub-populations towards a desynchronized state. It has been proposed that a CR pattern of stimulation may cause an ‘unlearning’ of pathologically persistent synchrony and synaptic connectivity and thus the beneficial effects on behavior may outlast the period of CR stimulation. Electrical CR neurostimulation of the subthalamic nucleus (STN) has been demonstrated to be efficacious in humans and non-human primates with sustained benefit up to 30 days after stimulation had been stopped.

Several studies have looked at different forms of peripheral stimulation in order to avoid the adverse effects of an invasive procedure and implanted hardware. CR patterns may also be achieved with non-invasive forms of stimulation. Acoustic CR stimulation for tinnitus targets pathological synchrony in the tonotopically organized auditory cortex by delivering four acoustic tones. These tones have different frequencies, which are centered around the patient's perceived tinnitus frequency in a non-invasive manner. In a proof of concept study, acoustic CR stimulation caused a significant decrease of tinnitus symptoms along with significant a reduction of tinnitus-related abnormal EEG oscillations and effective connectivity. In addition, acoustic CR stimulation has been shown to improve tinnitus for up to twelve months with no persistent adverse events.

Peripheral vibrotactile stimulation accesses central sensory networks and produces a characteristic cortical response. Skin mechanoreceptors can process visual, auditory and modified tactile information to achieve tactile-visual and tactile-auditory sensory substitution, and peripheral vibrotactile stimulation can be used to improve the perception of speech in profoundly deaf individuals. In PD, short bursts of vibrotactile stimulation applied to the trunk at the center of body mass in response to increased body sway can improve postural instability and decrease fall rate in PD, and vibrotactile stimulation can be used as a Go cue in gait initiation studies. A study remains desired to test the feasibility of long periods of peripheral CR vibrotactile stimulation as a potential therapy for Parkinson's disease.

Methods

Subjects

Six subjects (five male) with idiopathic PD consented to participate in a trial of peripheral vibrotactile CR stimulation. Subjects were excluded from the trial if they had significant cognitive decline or other comorbidities that interfered with their movement. Written and informed consent was obtained from each subject prior to the beginning of the study. The protocol was approved by the Stanford Institutional Review Board (IRB). One subject developed a gastrointestinal illness the day before he started the trial and decided not to continue.

Experimental Protocol

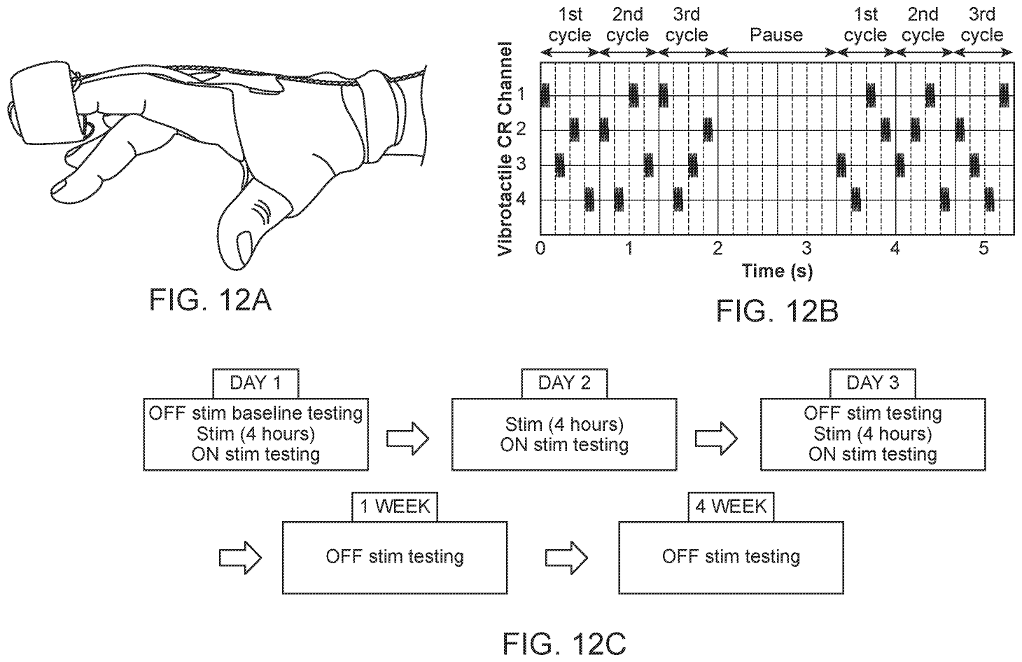

Subjects had a total of five study visits throughout the duration of the trial, which comprised of visits on three consecutive days, as well as at one and four weeks post-stimulation (FIG. 12C). Subjects received vibrotactile CR stimulation on the fingertips for about four hours on days 1, 2, and 3, totaling about twelve hours over all three days (EAI Engineering Acoustics Inc., Casselberry, Fla.) (FIG. 12A).

FIG. 12C details the evaluation schedule, which comprised of off therapy baseline testing before stimulation was started (day 1), ON stimulation testing (days 1-3), and off therapy testing (day 3, one and four weeks post stimulation). Four subjects were off medication (24 hours for long-acting and 12 hours for short acting dopaminergic medication) during the stimulation and at all evaluations. Three of these four subjects did not take any medications in between days 1, 2, and 3 by choice, and the fourth subject had deep brain stimulation (DBS) and turned his DBS back on overnight on days 1, 2, and 3.

The fifth subject was on medication at all visits except the baseline off therapy and one and four week follow-up. Time points on medication for this subject were excluded from analysis.

Due to hardware specifications, vibratory bursts were delivered to four different fingers (all fingers except for the thumb) of both hands with vibratory stimulators (C-2 tactors, EAI Engineering Acoustics Inc., Casselberry, Fla.). The vibrotactile CR stimulation pattern comprised of three cycles, each containing a randomized sequence of four vibratory bursts, equally spaced in time and followed by two silent cycles off stimulation (“pause”, FIG. 12B). The vibratory bursts had a vibration frequency of about 250 Hz and vibration amplitude of about 0.35 mm. The vibration amplitude was linearly ramped up within about 40 s after CR stimulation onset. CR cycle duration was about 660 ms, whereas vibratory burst duration was about 100 ms. The vibratory stimulators were fixed with Velcro tapes (FIG. 12A), and a substantially constant indentation of the stimulator's contactor surface was about 0.5 mm. The 3 cycles on, 2 cycles off pattern was repeated periodically. The random variation of the vibratory burst sequences and the 3:2 ON-OFF pattern were used to enhance the desynchronizing CR effect. The vibrotactile CR stimulation pattern was delivered to both hands, so that the same fingers of both hands were stimulated at the same time.

Assessment of the effect of vibrotactile CR stimulation included the Unified Parkinson's disease Rating Scale motor assessment (UPDRS III, minus rigidity and speech), assessed by a blinded rater, quantitative measures of forward walking (FW) and repetitive wrist flexion extension (rWFE), using wearable sensors. The self-paced rWFE task comprised of thirty seconds of repetitive flexion and extension; the subjects were instructed to flex and extend their hands at the wrist as quickly as possible after a “Go” command and to stop when instructed. For the FW task, subjects walked forwards for about 10 min, turned around, returned, and repeated this for a total of about 40 min of straight walking. Subjects were also given a customized adverse effects (AEs) questionnaire which asked about any AEs they were experiencing before, during, and after the stimulation at each visit.

The primary outcome was safety and tolerability of undergoing three days of four hour periods of vibrotactile CR stimulation. The secondary outcome variables were the UPDRS III score, gait arrhythmicity and asymmetry, and the rWFE metrics. The efficacy of vibrotactile CR stimulation was assessed by comparing the baseline off therapy UPDRS III and kinematics to those ON stimulation. The long-term effect of CR stimulation was assessed by comparing the off therapy UPDRS III and kinematics at baseline, before the third day of stimulation, and at one and four weeks after stimulation.

Data Acquisition and Analysis

Angular velocity during rWFE was measured using wearable gyroscopic sensors attached to the dorsum of each hand (Motus Bioengineering, Inc., Benicia, Calif.) and monitored by continuous video. The rWFE angular velocity data was sampled at about 1000 Hz and video was recorded at about 30 frames/second. Root mean square velocity (Vrms), frequency (cycles/second), coefficient of variation (standard deviation divided by the mean) of Vrms (CV_{Vrms}), coefficient of variation of the interstrike interval (CV_{ISI}), and coefficient of variation of distance (angular range) per cycle (CV_{dist}) were calculated for each movement epoch.

Kinematic data during FW was recorded using six wireless Opal® inertial measurement unit (IMU) sensors (APDM, Inc., Portland, Oreg., USA), attached to the top of each foot, to each shank, and to the lumbar, and chest trunk regions. Sampling rate for the IMU sensors was about 128 Hz. The gait measures were calculated using the gyroscope (angular velocity) signals from the shank IMUs. Care was taken to align the sensor on the shank, so that the positive Z axis was approximately lateral and recorded gait angular velocity in the sagittal plane. The data were filtered using a zero phase 8^{th} order low pass Butterworth filter with an about 9 Hz cut-off frequency and a principal components analysis was used to align the shank angular velocity with the sagittal plane. Using the aligned Z angular velocity, the beginning of the swing phase (positive slope zero crossing), end of swing phase (subsequent negative slope zero crossing) were identified. Swing and stride times were calculated from these time points. Swing and stride times were then used to calculate arrhythmicity and asymmetry. Arrhythmicity and asymmetry were calculated using periods of straight walking. Asymmetry and arrhythmicity were specified as: asymmetry=100×|ln(SSWT/LSWT)|, where SSWT and LSWT correspond to the leg with the shortest and longest mean swing time over the trials, respectively and arrhythmicity=the mean stride time coefficient of variation (CV) of both legs. A large stride time CV is indicative of a less rhythmic gait. Analysis was performed in LabVIEW (National Instruments, Inc.) and MATLAB (The MathWorks, Inc.).

The UPDRS III was scored by a blinded rater, with rigidity excluded. The subject was not blinded to the stimulation, as they could feel when the stimulation was on or off.

Statistics

To bound the number of comparisons among time points for the OFF to ON immediate stimulation effect, analysis focused on comparing baseline testing OFF stimulation with the second and third day ON stimulation testing points (after a total of about 8 and about 12 hours of vibrotactile CR stimulation, respectively). Similarly, for the long-term effect analysis, analysis focused on comparing baseline OFF testing to the day 3 OFF, day 4 OFF, and day 5 OFF time points. The statistical analysis of the immediate and long-term effect of stimulation in the OFF therapy state excluded the subject who was on medication during the trial. A one-way repeated measure ANOVA or one-way repeated measure ANOVA on Ranks and Dunnett's Method was used for both analyses. Turns during the FW task were removed from analysis, which resulted in 4 straight walking FW time segments. In order to account for this, a linear mixed effects model was used. For the immediate effect, visit day was a fixed effect and a factor variable with 3 levels (Baseline OFF, day 2 ON, and day 3 ON). For the long-term effect, visit day was also a fixed effect, and a factor variable with 4 levels (Baseline OFF, day 3 OFF, day 4 OFF, and day 5 OFF). For both linear mixed effects models, subject number was a random effect, and a random intercept was used in the model. Residuals were assessed for homoscedasticity and normality, and all statistical assumptions were met.

Results

Table 1 shows the demographic characteristics of the group, whose mean age was 66+/−6.8 years, and who were Hoehn Yahr Stage II or III.

TABLE 1
Patient Demographics

| | | | | Baseline |
|---|---|---|---|---|
| | | | Disease | UPDRS III |
| | | | Duration | OFF Therapy |
| Pt | Phenotype | Age | (years) | and Stimulation |
| 1 | TD | 58 | 2.25 | 21 |
| 2 | AR | 61 | 8.92 | 3 |
| 3 | TD | 69 | 3.92 | 28 |
| 4 | TD | 67 | 7.58 | 37 |
| 5 | TD | 75 | 5.92 | 16 |

Demographics of the five subjects. Blinded UPDRS III scores do not include rigidity or speech. TD = tremor dominant, AR = akinetic rigid.

Safety and Tolerability

There were no serious adverse effects (AEs) throughout the four week trial. All five subjects tolerated the total of about 12 hours of vibrotactile CR stimulation, and no subject had to stop the stimulation early. Although a few subjects stated that the stimulation felt strange at first (described as a ‘ticklish’ or ‘interesting’ sensation), no subjects reported worsening of their PD symptoms during the trial. AEs reported during stimulation included increased anxiety, increased tiredness, hypophonia, and trouble word-finding. These AEs may have been influenced by the subjects' off medication state. AEs reported between visits (while the subjects were not in the lab) included increased restless leg syndrome as one subject was falling asleep on days 1 and 2 and a mild increased temperature sensitivity in one subject between day 3 and the one week visit. During one visit, the patient who received the stimulation while on medications experienced slight tingling in the upper arm for about 3 seconds before fading.

Acute Effect of Vibrotactile Stimulation

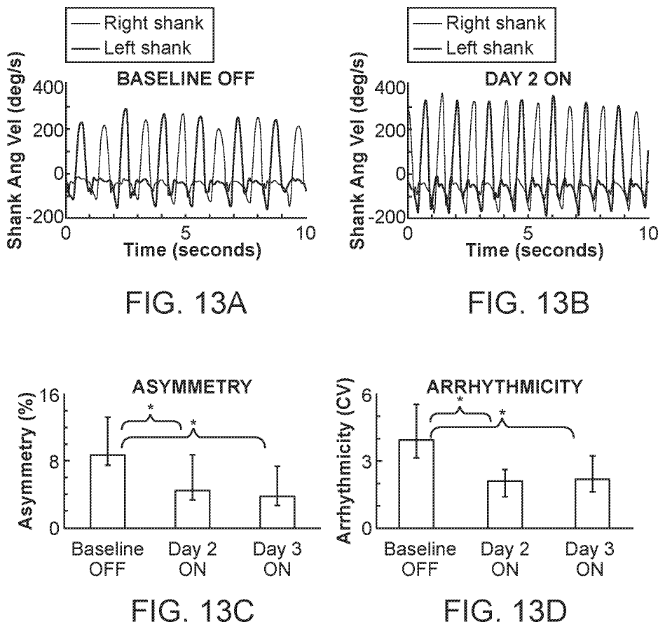

FIG. 13A and B demonstrates the shank angular velocity traces OFF and ON vibrotactile CR stimulation of a representative subject. Visual inspection indicates that the shank angular velocity, the cadence and the symmetry between legs improved ON versus OFF stimulation. FIG. 13C and D demonstrate the change in asymmetry (FIG. 13C) and arrhythmicity (FIG. 13D) for all the subjects on day 2 and day 3 compared to baseline. For the group, asymmetry and arrhythmicity of FW improved ON vibrotactile CR stimulation on day 2 (β=about −4.14, P<about 0.001 and β=about −0.02, P<about 0.001, respectively) and day 3 (β=about −4.90, P<about 0.001 and β=about −0.02, P<about 0.001, respectively). A One Way RM ANOVA showed an improvement in frequency of rWFE (F(2, 14)=about 7.44, P=about 0.006), with a significant difference between day 1 OFF stimulation testing and ON stimulation on day 2 (P=about 0.006) and day 3 (P=about 0.016). No other metrics of WFE or the total UPDRS III improved ON versus OFF stimulation.

Long-Term Effect of Vibrotactile Stimulation, OFF Therapy

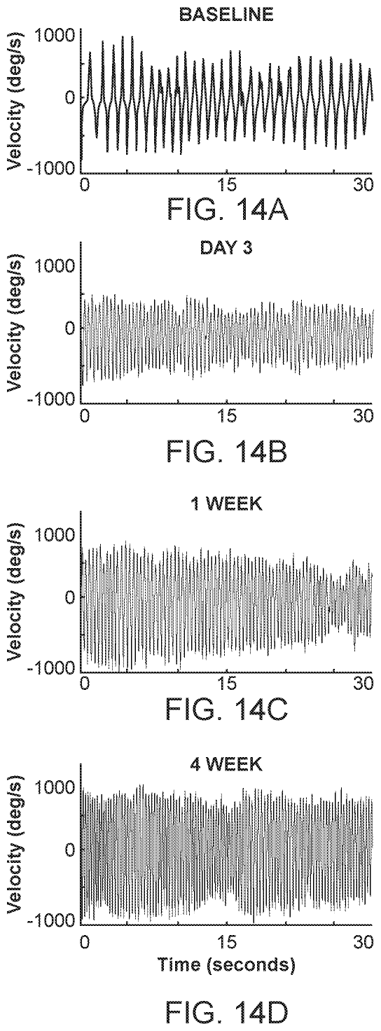

To examine the possible long-term effects of vibrotactile stimulation, comparison is made of baseline off medication, OFF stimulation (off/OFF) testing to off/OFF testing on the third day, before the last day of vibrotactile stimulation, and to off/OFF testing at one and four weeks after the three days of treatment. FIG. 14 shows a representative subject's WFE velocity traces at all the off/OFF testing time points. Visual inspection demonstrates improvement in the frequency of WFE at each time point compared to baseline and improvement in both velocity and frequency at the time points one and four weeks after vibrotactile stimulation had ended. For the group, the off/OFF Vrms significantly improved during the WFE task (F(3, 21)=about 6.87, p=about 0.002) at the one week time point (P=about 0.004) and at the four week time point (P=about 0.006). There was a similar improvement in CV_{ISI} at the 1 week and 4 week time points (H(3)=about 9.75, p=about 0.021). No WFE metrics improved significantly for the group at the day 3 time point. There was also a significant improvement in off/OFF FW asymmetry on day 3 (β=about −3.09, P=about 0.004) and at both 1 and 4 weeks after treatment (β=about −3.32, P=about 0.001 and β=about −3.99, P<about 0.001, respectively). There were no significant changes in the UPDRS III scores.

The Acute and Long-Term Effect of Vibrotactile CR Stimulation on Medication

One subject performed the off/OFF evaluations but was unable to stay off medication for the duration of the vibrotactile stimulation. The ON stimulation data was excluded from the group analysis. Table 2 details the gait data for this subject. Gait arrhythmicity and asymmetry improved on compared to off medication on day 1, no stimulation. There appeared to be improvement in asymmetry, on medication/ON stimulation (on/ON), on day 3 compared to the on/OFF on day 1 and on/ON on day 2. The on medication kinematic metrics of the rWFE task remained relatively constant ON and OFF stimulation throughout days 1, 2, and 3 (data not shown). The subject did show long-term improvement in both rWFE and FW metrics off/OFF at the one and four week visits that followed the same trend in long-term improvement as the rest of the group, when vibrotactile stimulation was performed in the off medication state.

TABLE 2
Gait Arrhythmicity and Asymmetry in
the subject stimulated on medication

| | Asymmetry | Arrhythmicity |
|---|---|---|
| Day 1 OFF/off | 4.30 | 2.51 |
| Day 1 OFF/on | 2.79 | 1.64 |
| Day 2 ON/on | 2.81 | 2.08 |
| Day 3 OFF/on | 3.98 | 1.99 |
| Day 3 ON/on | 1.26 | 1.51 |
| 1 Week OFF/off | 3.25 | 2.64 |
| 4 Week OFF/off | 3.37 | 1.25 |

OFF/off refers to off stimulation, off medication, while ON/on refers to on stimulation and on medication.

Discussion

This study has demonstrated that three consecutive days of peripheral vibrotactile CR stimulation was safe and tolerable and yielded evidence of both acute and long-term improvements in quantitative metrics of gait impairment and of bradykinesia in PD. Gait asymmetry and arrhythmicity, as well as the frequency of the rWFE task, improved acutely ON stimulation, on the second and third day of stimulation in comparison to the OFF stimulation and therapy baseline. Three days of peripheral vibrotactile CR stimulation had long-term or cumulative effect on both gait impairment and wrist bradykinesia in the off therapy state. Gait asymmetry and wrist angular velocity and regularity (rWFE Vrms and CV_{ISI}, respectively) improved at one and four weeks after the three days of vibrotactile stimulation, when the subjects were off medication. One subject, who did not wish to be off medication during stimulation, also demonstrated a long-term improvement in gait arrhythmicity and asymmetry.

These preliminary results indicate that peripheral vibrotactile CR stimulation can improve gait and bradykinesia in PD, both acutely and in the long-term and provide new avenues for non-invasive stimulation as a potential therapy in PD. The long-term improvements indicate that peripheral CR stimulation may be successfully desynchronizing central sensorimotor networks.

Conclusions

CR vibrotactile stimulation is a safe and tolerable potential non-invasive treatment for PD patients. This study shows promising preliminary results that indicate peripheral vibrotactile CR stimulation exerts acute and long-term benefits for gait impairment and bradykinesia in PD. The cumulative or long-term therapeutic effect indicates that the peripheral form of CR stimulation may allow an ‘unlearning’ of pathological neural synchrony in sensorimotor networks in PD. These results support the implementation of a larger, sham-controlled trial of non-invasive peripheral vibrotactile CR stimulation in PD.

As used herein, the singular terms “a,” “an,” and “the” may include plural referents unless the context clearly dictates otherwise. Thus, for example, reference to an object may include multiple objects unless the context clearly dictates otherwise.

As used herein, the terms “substantially,” “substantial,” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a range of about 1 to about 200 should be understood to include the explicitly recited limits of about 1 and about 200, but also to include individual values such as about 2, about 3, and about 4, and sub-ranges such as about 10 to about 50, about 20 to about 100, and so forth.

Some embodiments of this disclosure relate to a non-transitory computer-readable storage medium having or storing computer code or instructions thereon for performing various computer-implemented operations. The term “computer-readable storage medium” is used to include any medium that is capable of storing or encoding a sequence of instructions or computer code for performing the operations, methodologies, and techniques described herein. The media and computer code may be those specially designed and constructed for the purposes of the embodiments of this disclosure, or may be of the kind available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs), and ready-only memory (ROM) and random-access memory (RAM) devices. Examples of computer code include machine code, such as produced by a compiler, and files containing higher-level code that are executed by a processor using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computing device) to a requesting computer (e.g., a client computing device or a different server computing device) via a transmission channel. Another embodiment of the disclosure may be implemented in hardwired circuitry in place of, or in combination with, processor-executable software instructions.

While this disclosure has been described with reference to the specific embodiments thereof, it should be understood by those skilled in the art that various changes may be made and equivalents may be substituted without departing from the true spirit and scope of this disclosure as defined by the appended claims. In addition, many modifications may be made to adapt a particular situation, material, composition of matter, method, operation or operations, to the objective, spirit and scope of this disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of this disclosure. Accordingly, unless specifically indicated herein, the order and grouping of the operations are not a limitation of this disclosure.

What is claimed is:

1. An apparatus for treatment of a patient using vibrotactile multi-channel stimulation, comprising:
a plurality of vibratory stimulators;
a plurality of fastening mechanisms to secure respective ones of the vibratory stimulators to respective parts of a hand of the patient; and
a controller connected to the vibratory stimulators to direct operation of the vibratory stimulators.

2. The apparatus of claim 1, wherein the fastening mechanisms are configured to secure respective ones of the vibratory stimulators to apply a substantially constant indentation to the respective parts of the hand of the patient.

3. The apparatus of claim 1, further comprising a glove, wherein the vibratory stimulators and the fastening mechanisms are affixed to the glove.

4. The apparatus of claim 1, wherein the controller is configured to:
direct the vibratory stimulators to apply vibrotactile stimuli according to a treatment cycle frequency in a range of 0.1 Hz to 60 Hz; and
within a treatment cycle, direct each of the vibratory stimulators to apply a vibratory burst at a different, respective time within the treatment cycle and with a burst frequency different from the treatment cycle frequency.

5. The apparatus of claim 4, wherein the burst frequency is in a range of 100 Hz to 500 Hz, and a peak to peak amplitude of the vibratory burst is in a range of 0.01 mm to 0.1 mm.

6. The apparatus of claim 4, wherein the burst frequency is in a range of 10 Hz to 100 Hz, and a peak to peak amplitude of the vibratory burst is in a range of 0.1 mm to 0.3 mm.

7. The apparatus of claim 4, wherein the controller is configured to vary a time sequence by which vibratory bursts are applied by the vibratory stimulators across multiple treatment cycles.

8. The apparatus of claim 1, wherein the controller is configured to direct the vibratory stimulators to apply vibrotactile stimuli that are phase-shifted with respect to one another.

9. The apparatus of claim 8, wherein, within a treatment epoch, the controller is configured to direct the vibratory stimulators to continuously apply vibrotactile stimuli that are time-overlapped but are phase-shifted with respect to one another.

10. The apparatus of claim 8, wherein the controller is configured to vary relative phase shifts by which vibrotactile stimuli are applied by the vibratory stimulators across multiple treatment epochs.

11. The apparatus of claim 1, wherein the vibratory stimulators include piezoelectric actuators.

12. A method for treatment of a patient using vibrotactile multi-channel stimulation, comprising:
applying a first substantially constant indentation to a first part of the skin of the patient during a treatment cycle;
while applying the first substantially constant indentation during the treatment cycle, applying a first vibratory burst to the first part of the skin of the patient;
applying a second substantially constant indentation to a second part of the skin of the patient during the treatment cycle; and
while applying the second substantially constant indentation during the treatment cycle, applying a second vibratory burst to the second part of the skin of the patient,
wherein the first vibratory burst and the second vibratory burst are applied at different times during the treatment cycle.

13. The method of claim 12, wherein a duration of each of the first vibratory burst and the second vibratory burst is less than a duration of the treatment cycle.

14. The method of claim 12, wherein a burst frequency of each of the first vibratory burst and the second vibratory burst is in a range of 100 Hz to 500 Hz, and a peak to peak amplitude of each of the first vibratory burst and the second vibratory burst is in a range of 0.01 mm to 0.1 mm.

15. The method of claim 12, wherein a burst frequency of each of the first vibratory burst and the second vibratory burst is in a range of 10 Hz to 100 Hz, and a peak to peak amplitude of each of the first vibratory burst and the second vibratory burst is in a range of 0.1 mm to 0.3 mm.

16. A method for treatment of a patient using vibrotactile multi-channel stimulation, comprising:
applying a first substantially constant indentation to a first part of the skin of the patient during a treatment epoch;
while applying the first substantially constant indentation during the treatment epoch, applying a first vibrotactile stimuli to the first part of the skin of the patient;
applying a second substantially constant indentation to a second part of the skin of the patient during the treatment epoch; and
while applying the second substantially constant indentation during the treatment epoch, applying a second vibrotactile stimuli to the second part of the skin of the patient,
wherein the first vibrotactile stimuli and the second vibrotactile stimuli are time-overlapped but are phase-shifted with respect to one another during the treatment epoch.
